(19) United States
(12) Patent Application Publication
(10) Pub. No.: US 2003/0142953 A1
(43) Pub. Date: Jul. 31, 2003

(54) Album generation program and apparatus and file display apparatus

(75) Inventors: Masahiro Terada, Asaka-shi (JP); Masakazu Nishijima, Asaka-shi (JP)

Correspondence Address: McGinn & Gibb, PLLC, Suite 200, 8321 Old Courthouse Road, Vienna, VA, 22182-3817, US

(73) Assignee: Fuji Photo Film Co., Ltd., Kanagawa (JP)

(21) Appl. No.: 10/354,138

(22) Filed: Jan. 30, 2003

(30) Foreign Application Priority Data
Jan. 31, 2002 (JP) 2002-022942
Jan. 31, 2002 (JP) 2002-022943

(51) Int. Cl. H04N 5/783; H04N 5/781; G11B 27/00

(52) U.S. Cl. 386/46; 386/69; 386/70; 386/125

(57) ABSTRACT

A computer is directed to select one or more folders containing an image file on at least one of the lower hierarchical levels, and record an image file contained in and below the selected folders on a CD-R when a storing process is specified, and generates a CD album. The album generation program sequentially searches folders having an image file immediately below the folders when the image file is recorded on the CD-R, generates a new folder for the folder having an image file immediately below the folder, and copies a target image file as a new image file in the new folder, thereby giving a folder name and a file name automatically generated according to DCF rule to the stored new folder and new image file.

### BACKGROUND OF THE INVENTION

1. Field of the Invention

The present invention relates to an album generation program and apparatus, and a file display apparatus, and more specifically, to a technology of generating an appropriate electronic album for storing image data accumulated on a hard disk of a personal computer onto a secondary storage medium such as a CD-R (compact disc recordable), etc., and displaying an image file, etc. recorded on a non-rewritable storage medium such as a CD-R, etc.

2. Description of the Related Art

The widespread use of digital cameras has allowed users to easily generate digital image data. A memory card is normally used as a medium for recording image data captured by a digital camera. However, the medium is still expensive for a storage medium such as a video cassette for a video tape recorder. Therefore, the image data captured by a digital camera is copied and generally stored in a large capacity storage device such as a hard disk, etc. of a personal compute.

As the next step, there has been the necessity to back up the stored image data on a hard disk using a secondary storage medium such as a CD-R, etc. Actually, some pieces of application software have already been commonly provided.

However, the function of the conventionally marketed image data processing device is either the function of recording data on the hard disk as backup data onto a secondary storage medium or the function of recording the data as an electronic album onto the secondary storage medium with the appearance for inspection taken into account, thereby lacking the function of recording the data as backup data onto the secondary storage medium with the secondary use taken into account.

For example, the image data processing device described in Japanese Patent Application Publication No. 10-320546 is designed to allow the image data to be inspected on a Web browser by storing image data as incorporated into the template of an HTML (hypertext markup language). Similarly, the device described in Japanese Patent Application Publication No. 2000-357169 automatically generates inspection information by an HTML representation when data is copied from a digital camera to a hard disk (or from a hard disk to a secondary storage medium) and stores the copied data. In these devices, however, a secondary use of the original image data is not taken into consideration.

Therefore, the above-mentioned conventional image data processing devices fail in solving the problem that the image data on the hard disk already accumulated by a user in a complicated folder hierarchy has to be optimally arranged on a secondary storage medium.

On the other hand, Japanese Patent Application Publication No. 2000-41208 discloses a device which compares an image filing stamp recorded on a storage medium such as a CD-R, etc. with a time stamp in a reproduction environment, and displays as an initial image the image file stored on a similar month and day in a different year on the storage medium. However, although this device is convenient because an image at the current time (season) of the year is initially displayed when the preceding images are remembered and confirmed, no consideration is made for a browsing operation on the subsequent images.

Furthermore, Japanese Patent Application Publication No. 2000-331008 discloses a device which records the operation of a user on the image database as history information, requires no explicit input of the user by using the history information, and extracts important picture information about a target picture, thereby enabling re-search and re-ordering. However, although this device is convenient as a device for a specific picture database, it cannot function with various picture databases and storage media, or is not suitable for more common browsing or filing operation since it is specialized for retrieval.

### SUMMARY OF THE INVENTION

The present invention has been developed to solve the above-mentioned problems, and aims at providing an album generation program and apparatus capable of automatically converting image data stored in a complicated folder hierarchy into a storage form appropriate for a secondary use in a printing service, and then storing the converted data on a storage medium, and capable of storing image data without losing the information about a folder name or a file name before conversion with images easily inspected and the correspondence between the image files before and after conversion stored with an identifiable appearance information.

Furthermore, the present invention can hierarchically display data such as an image file recorded on a non-rewritable storage medium such as a CD-R, etc., operate a file by transfer, deletion, etc. of a file and a folder, and display a file in the state of the preceding filing operation when a file on the storage medium is displayed next.

In order to attain the above-mentioned object, the present invention is directed to an album generation program which is used to direct a computer to perform a function of selecting at least one folder containing an image file on at least one of lower hierarchical levels, and recording an image file contained in and below the selected folder onto a storage medium when a storing process is specified, the program causing the computer to perform the functions of: when the image file is recorded on the storage medium, sequentially searching folders having an image file immediately below the folders; generating a new folder for the folder having an image file immediately below the folder, and storing a target image file as a new image file in the new folder, thereby converting an existing record structure into a record structure formed by the new folder in the same hierarchy; and giving a folder name and a file name automatically generated according to a predetermined naming rule to the stored new folder and new image file.

According to the present invention, for example, although image files are accumulated in a complicated folder hierarchy on a hard disk, a new folder is generated such that an image file can be arranged immediately below the folder. Thus, each of the newly generated folders is located in the same hierarchy, and a corresponding image file is stored as a new image file in the new folder, thereby converting the existing record hierarchy into a simple record hierarchy. Thus, the generated folder and the image file stored in the folder are assigned a folder name and a file name automatically generated according to the naming rule in a DCF (Design rule for Camera File system), etc.

Thus, the newly generated image file can be uniquely specified by a folder name (folder number) and a file name (file number), the new folder and the new image file are stored on a secondary storage medium such as a CD-R, etc., and the secondary storage medium and a print order slip recording the folder name (folder number) and the file name (file number) are brought to a print service shop, thereby simply placing a printing order.

According to another aspect of the present invention, the computer is further caused to perform the functions of: generating inspecting index information listing images of the new image files as thumbnail images including the information displaying as identifiable a correspondence between a new image file and an image file before conversion of a record structure; and recording the inspecting index information on the storage medium.

That is, the inspecting index screen can be displayed by opening on a browser the inspecting index information recorded on the storage medium. Furthermore, the information displaying as identifiable the correspondence between the image files before and after conversion refers to the information (folder name, file name, etc.) about each of the image files before and after conversion, the information about an image file before conversion, and the link information for opening a new image file after conversion. That is, when the information about the image files before and after conversion is recorded, the folder names, the file names, etc. before and after conversion can be simultaneously displayed on the inspecting index screen, thereby identifying the correspondence between the image files before and after conversion. When the information about an image file before conversion and the link information for opening a new image file after conversion are recorded, the folder name, the file name, etc. before conversion can be displayed on the inspecting index screen, and the folder name and the file name of the new image file can be checked on the screen opened by opening the new image file according to the link information from the inspecting index screen.

According to a further aspect of the present invention, the computer is further caused to perform the functions of: generating inspecting index information for listing images of the new image file as thumbnail images including the link information for opening a corresponding new image file from the thumbnail images; and recording the inspecting index information on the storage medium.

In order to attain the above-mentioned object of, the present invention is also directed to an album generation apparatus, comprising: a folder selection instruction device which directs selection of a desired folder from a folder containing an image file in at least one lower hierarchical level; a storage instruction device which directs a storing process of an image file included in and below the folders selected by the folder selection instruction device; and a storage device which stores an image file contained in and below the folder selected by the folder selection instruction device into the storage medium when the storage instruction device directs a storing process, wherein the storage device comprises: a device which sequentially searches at least one folder having an image file immediately below the folder; a device which generates a new folder on the same hierarchy for at least one folder having the image file immediately below the folder, and stores in the new folder a target image file as a new image file; and a device which assigns a folder name and a file name automatically generated according to a predetermined naming rule to the new folder and the new image file.

That is, to the non-rewritable storage medium such as a CD-R, etc., a file including an image file, etc. is written together with a script file containing the information about the correspondence between the actual folder hierarchy and the virtual folder hierarchy of the file and the unique identification information.

When the storage medium is installed in the read device, it is determined whether or not a script file having the same identification information as the script file in the storage medium is stored in the storage device. If it is determined that the script file is not stored in the storage device, then a virtual folder hierarchy is displayed according to the script file recorded on the storage medium. If it is determined that the script file is stored in the storage device, then a virtual folder hierarchy is displayed according to the script file having the same identification information in the storage device.

Filing operations such as generating a new folder, deleting a folder, transferring a file, deleting a file, etc. can be performed in the displayed virtual folder hierarchy, and the script file containing the results of the filing operations is stored in the storage device. Thus, when a storage medium on which a filing operation is performed is installed next time, a virtual folder hierarchy can be displayed according to the script file stored in the storage device, thereby enabling the optimized storage medium to be browsed.

Since a virtual folder hierarchy is associated with an actual folder hierarchy, a file can be opened on a storage medium by specifying a desired file in the virtual folder hierarchy.

According to another aspect of the present invention, the control device overwrites the script file recorded on the storage medium in the storage device when an instruction to return control to the virtual folder hierarchy on the storage medium is input.

According to a further aspect of the present invention, the apparatus further includes: a device which records in the script file the history of the frequency of displaying a file in the virtual folder hierarchy; and a device which displays as rearranged the virtual folder hierarchies in an ascending order of the display frequency according to the history of the display frequency recorded in the script file.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a block diagram showing an example of a configuration of hardware of a personal computer having the album generation program and the file display apparatus according to the present invention;

FIG. 2 shows a display screen of a monitor of viewer software;

FIG. 3 shows a display screen of a monitor where the album generation program is activated;

FIG. 4 shows a display screen of a monitor of the album generation program when a folder to be written to a CD-R is added;

FIG. 5 shows a display screen of a monitor when data to be written to a CD-R is completely generated by the album generation program;

FIGS. 6(A) and 6(B) show the case in which a record structure is converted from a tree structure of a hard disk device into a tree structure of data to be written to a CD-R;

FIG. 7 is a chart showing the conversion of a folder name and a file name;

FIG. 8 is a flowchart of the procedure of converting a record hierarchy and generating a folder name and a file name;

FIG. 9 is a flowchart of the procedure of converting a record hierarchy and generating a folder name and a file name;

FIG. 10 is a chart showing an example of a record structure in a CD-R;

FIG. 11 shows an example of displaying a monitor screen displayed according to the HTML file (FPVINDEX.HTML on top page) written to a CD-R;

FIG. 12 is a chart showing a thumbnail page linked with a button of each folder of the top page;

FIG. 13 shows an example of displaying a monitor screen displayed according to the thumbnail page;

FIG. 14 shows an example of a printing order slip in placing a printing order using a secondary storage medium such as a CD-R, etc.;

FIG. 15 shows the case in which a record structure is converted from a tree structure of a hard disk device into a tree structure of data to be written to a CD-R;

FIG. 16 shows an example of describing a script file to be written to a CD-R;

FIG. 17 is a flowchart for explanation of an operation of the file display apparatus according to the present invention;

FIG. 18 shows a virtual folder hierarchy displayed according to the script file shown in FIG. 16;

FIG. 19 shows an example of a filing operation;

FIG. 20 shows the process of updating a script file in internal memory according to a filing operation result shown in FIG. 19;

FIG. 21 shows the process of updating a script file in internal memory according to a filing operation result; and

FIG. 22 shows a virtual folder hierarchy displayed according to the script file shown in FIG. 21.

### DETAILED DESCRIPTION OF THE PREFERRED EMBODIMENTS

A preferred embodiment of the album generation program according to the present invention is described below in detail by referring to the attached drawings.

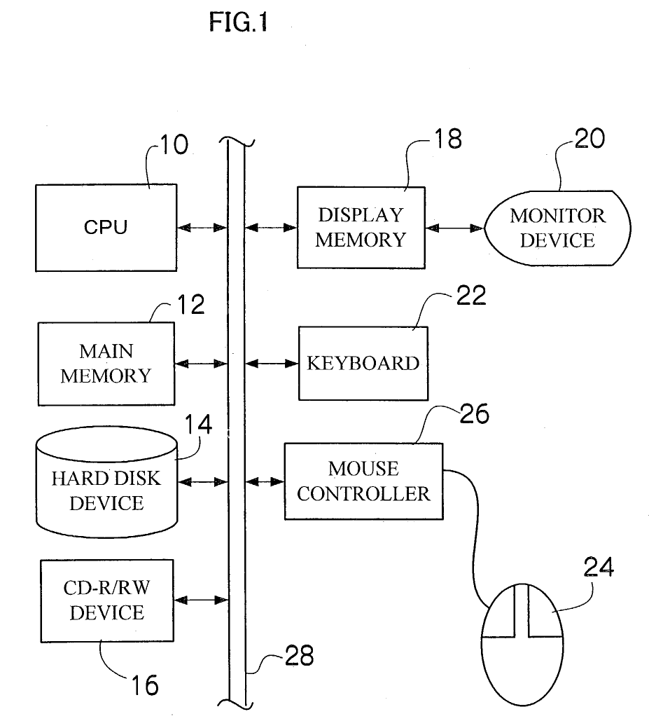

FIG. 1 is a block diagram showing an example of a configuration of hardware of a personal computer having the album generation program according to the present invention.

As shown in FIG. 1, the personal computer comprises a central processing unit (CPU) 10 mainly for controlling the operation of each component; main memory 12 for storing a control program of the unit and functions as a work area when the program is executed; a hard disk device 14 for storing an operating system (OS) of a personal computer, the album generation program according to the present invention, a file displaying program, various application software, an image of a user, etc.; a CD-R/RW device 16 capable of reading from a CD-ROM and reading from and writing to a CD-R; a display memory 18 for temporarily storing display data; a monitor device 20 such as a CRT monitor, a liquid crystal monitor, etc. for displaying an image, a character, etc. from the image data, character data, etc. from the display memory 18; a keyboard 22; a mouse 24 as a position input device; a mouse controller 26 for detecting the state of the mouse 24 and outputting the position of the mouse pointer of the monitor device 20 and a signal of the state, etc. of the mouse 24 to the CPU 10; and a bus 28 for connecting each of the above-mentioned components.

Since the personal computer with the above-mentioned configuration is well known except the album generation program and the file display program stored in the hard disk device 14, the detailed explanation of each component is omitted.

Described below is the outline of the album generation program according to the present invention.

When the user specifies a folder storing an image file in a lower hierarchical level in the hard disk device 14, the album generation program arranges the entire hierarchy below the folder in the CD album format appropriate for recording in a CD-R, and directs the computer to operate to write it in other areas and/or CD-R in the hard disk device 14.

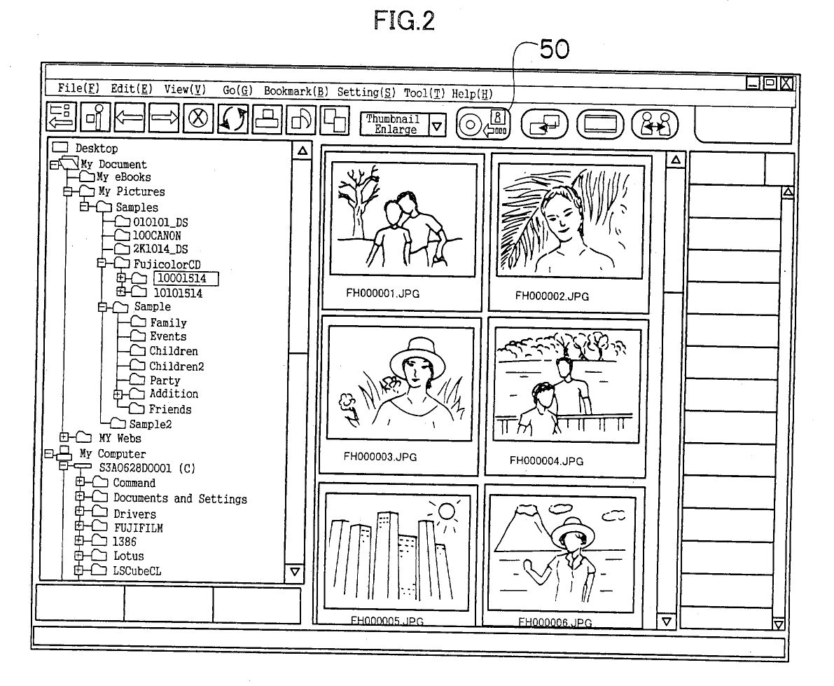

FIG. 2 shows the case in which viewer software is activated, a folder in the hard disk device 14 is specified, and a list of images of image files stored in the folder is displayed.

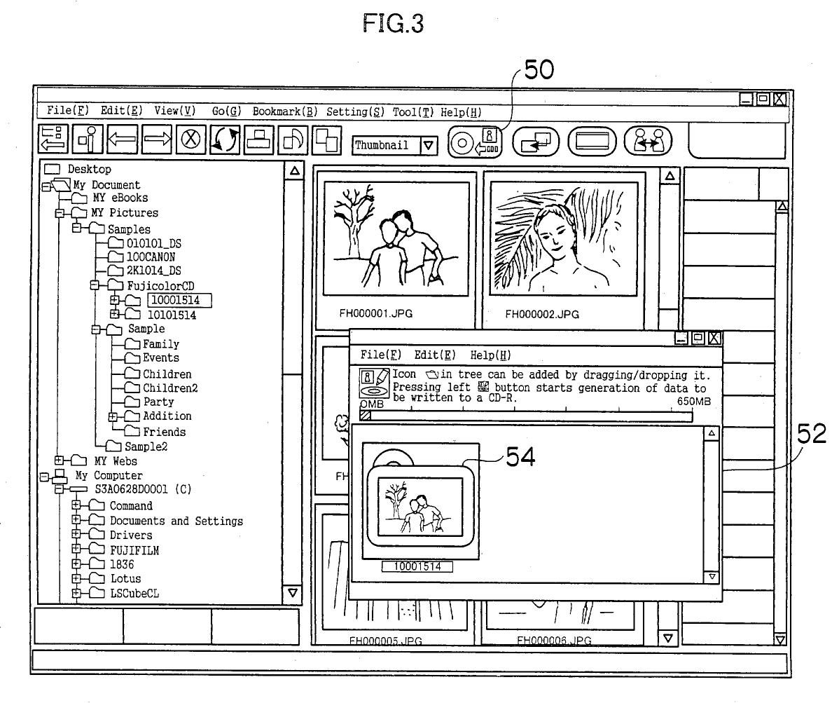

When a button 50 for generation of a CD album is clicked, the album generation program is activated, and a window 52 for generation of a CD album opens as shown in FIG. 3. The album generation program can be also activated by directly specifying the program.

When the album generation program is activated by clicking the button 50 on the screen of the viewer software, the folder opened by the viewer software is selected as a folder for generation of an album in the window 52 for generation of a CD album as shown in FIG. 3, and an icon 54 indicating the selection is displayed in the window 52.

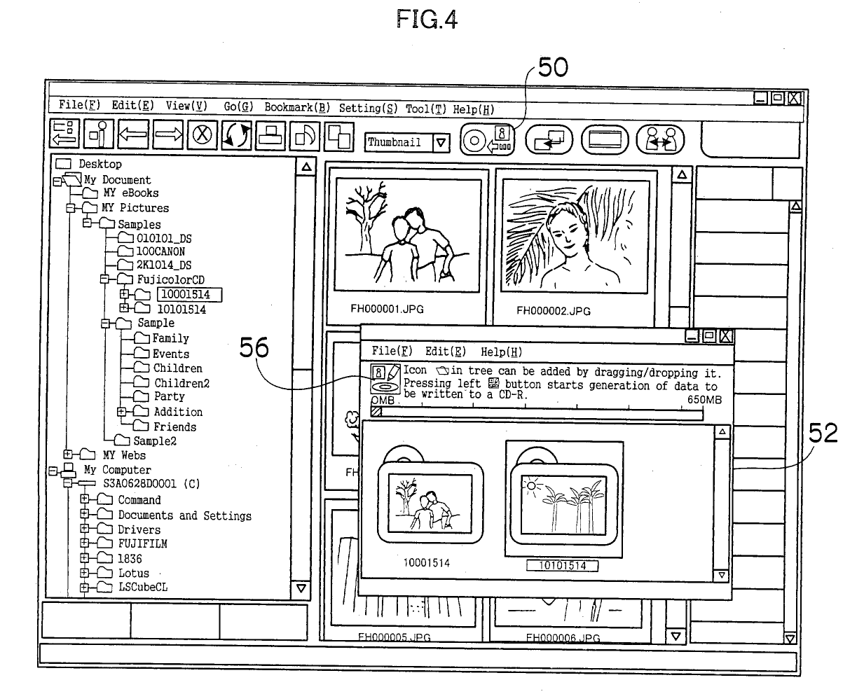

Additionally, by dragging and dropping the folder in the right tree structure shown in FIG. 4 to the window 52, the folder can be additionally selected. A selected folder can be in any hierarchy in the tree structure. In the window 52, a total size (MB) of the selected folder is displayed.

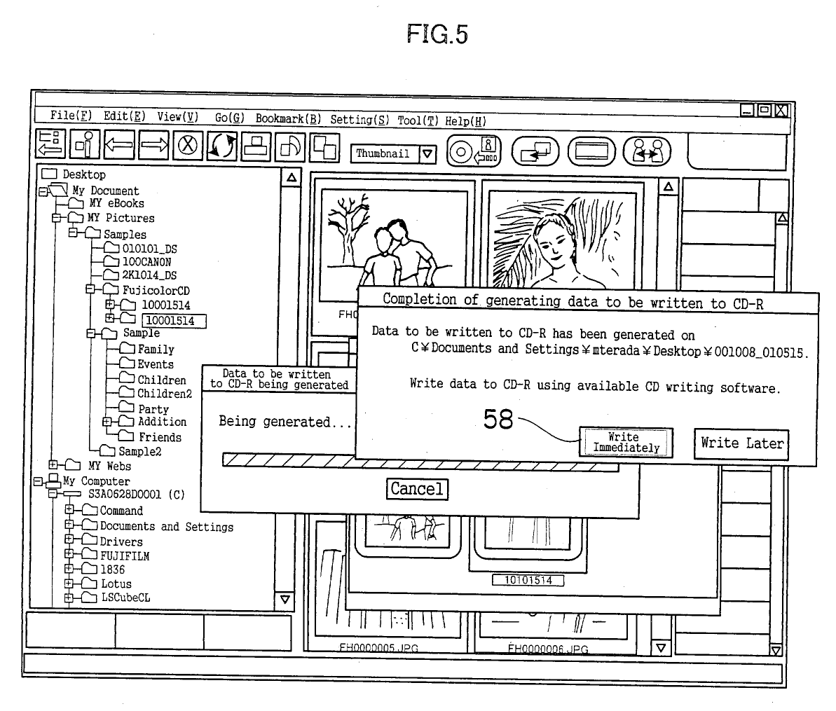

When the selection of the folder is completed, a button 56 in the window 52 for generation of a CD album is clicked, thereby starting the generation of data to be written to a CD-R. When the generation of the data to be written to a CD-R is completed, a generation completion message is displayed as shown in FIG. 5. If an “immediate write” button 58 is clicked, then an application for write to a CD-R is activated, and the data to be written to a CD-R generated by the CD-R/RW device 16 is written to the CD-R. The generated data to be written to a CD-R is stored in the hard disk device 14, and can be written to the CD-R.

Described below is the above-mentioned data to be written to a CD-R.

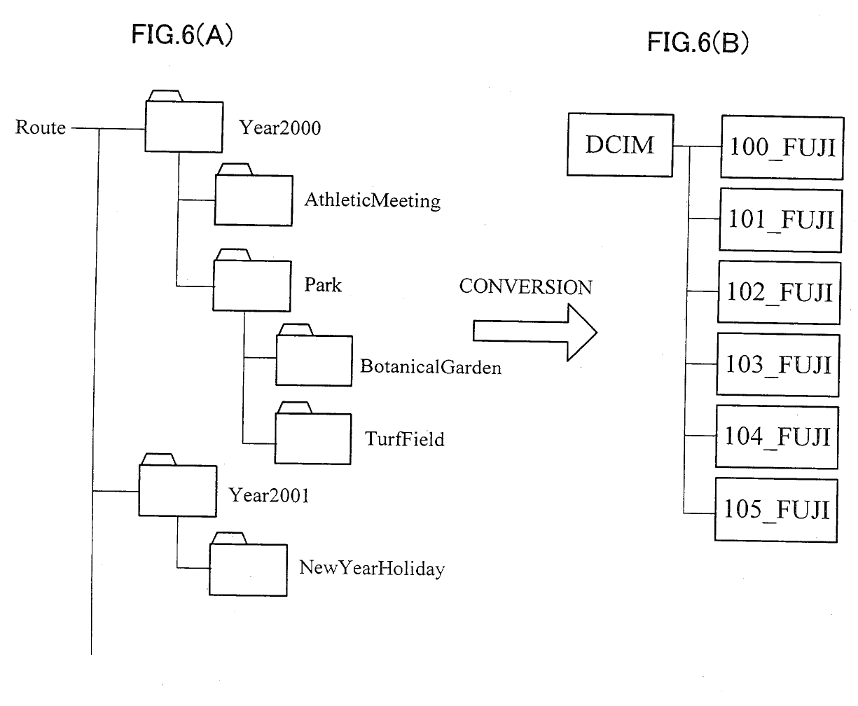

FIGS. 6(A) and 6(B) show the case in which a record structure is converted from a tree structure of the hard disk device 14 into a tree structure of data to be written to a CD-R.

For example, when folders of 2000 and 2001 are selected from the tree structure in FIG. 6(A) of the hard disk device 14, the folders and those below the folders and the image files are converted into the record structure as shown in FIG. 6(B).

That is, immediately below the DCF image root directory DCIM (Digital Camera IMmages), DCF folders (100_FUJI through 105_FUJI) are generated in the same hierarchy, and an image file corresponding to each DCF folder is copied.

Furthermore, a folder name and a file name are automatically generated according to a predetermined naming rule and assigned to the generated DCF folder and image file.

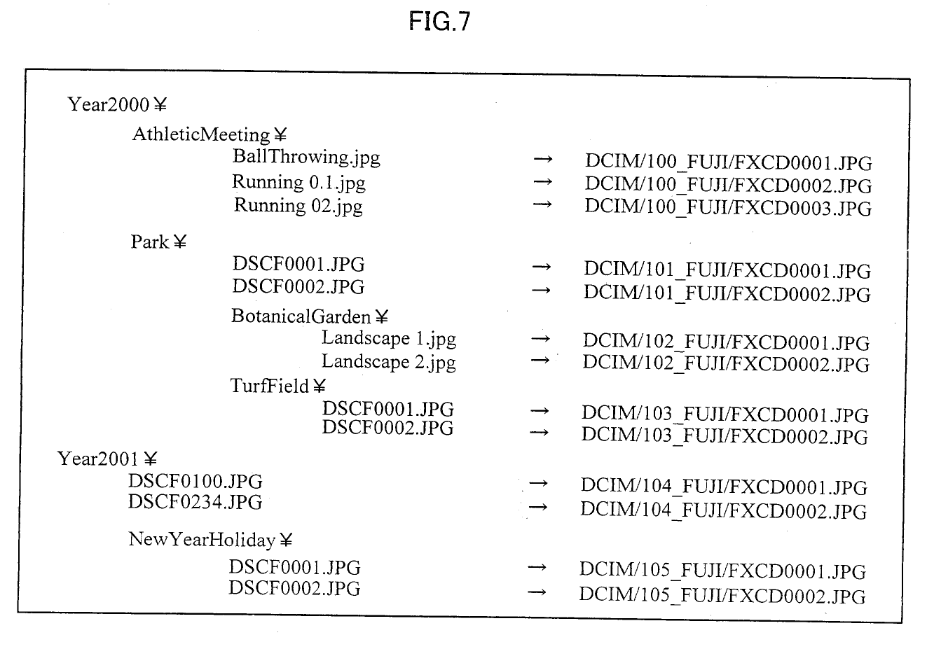

According to the embodiment, a folder name and a file name are automatically generated according to the DCF rule, and the folder name and the file name before conversion shown on the left in FIG. 7 are converted in to the folder name and file name on the right in FIG. 7.

TABLE 1

| | Folder Number | Free Character |
|---|---|---|
| Prescription | (100-999) | (5 characters) |
| Example | 100 | ABCDE |

If there are no DCF folders immediately below the DCF image root directory DCIM, then the initial value of the folder number can be arbitrarily determined. If there is a DCF folder, then the serial number of the largest number+1 is recommended for the folder number of a newly generated DCF folder. The file name of an image file (DCF file) is generated as shown in the following table 2.

TABLE 2

| | Free Character | Folder Number |
|---|---|---|
| Prescription | (4 characters) | (0001-9999) |
| Example | ABCD | 0001 |

When there are no DCF files in the DCF folder, an arbitrary initial value of a file number can be set. When there is a DCF file, a serial number of the largest number+1 is recommended for the file number of a newly generated file number.

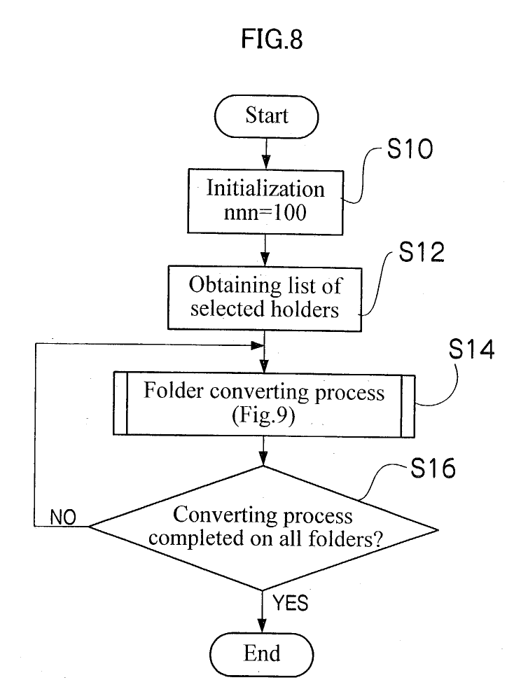

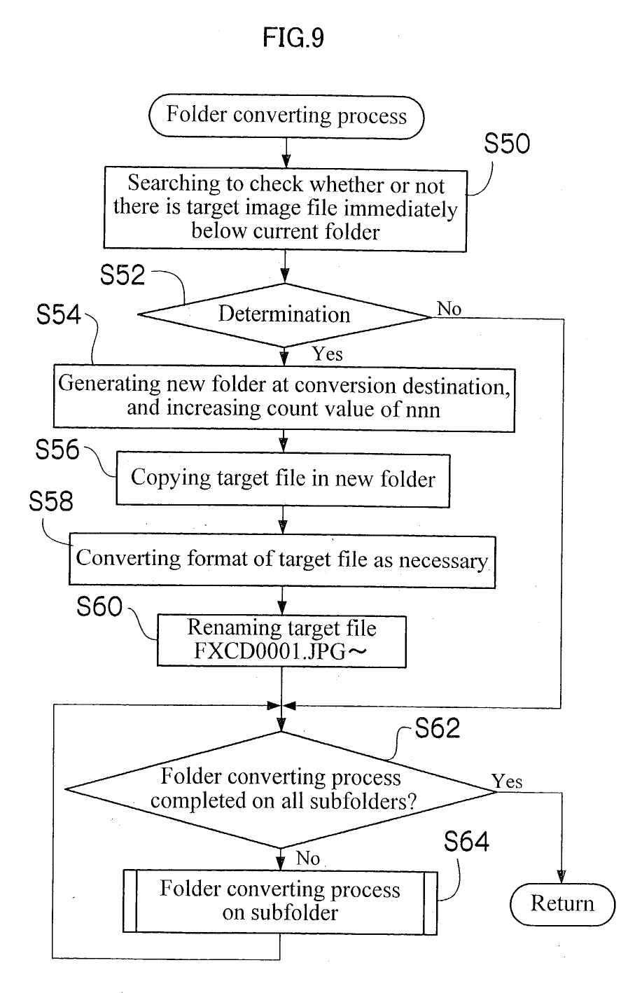

Then, the procedure of converting the record hierarchy and generating a folder name and a file name is described below by referring to the flowcharts shown in FIGS. 8 and 9.

As described above, when the generation of data to be written to a CD-R is specified, the folder number nnn of the folder names of the DCF folder is set to the initial value 100 as shown in FIG. 8 (step S10). Then, a list of the folder selected from the hard disk device 14 is obtained (step S12).

Then, the folder converting process is sequentially performed on each folder in the above-mentioned list (step S14). The folder converting process is performed in the procedure shown in FIG. 9.

As shown in FIG. 9, it is checked whether or not there is a target image file immediately below the target folder (folder to be converted) (step S50). For example, although there is no image files immediately below the folders of 2000 shown in FIG. 7, there is an image file immediately below the folder of the athletic meeting on the lower hierarchical level of the folder of 2000.

If there is an image file immediately below a folder, then a new folder (DCF folder) is generated at a conversion destination, the folder number nnn is increased by 1, thereby assigning a folder name (step S54). That is, a folder name is assigned according to the above-mentioned naming rule of the DCF. When a DCF folder is initially generated immediately below the DCF image root directory DCIM, the folder number is the one initialized in step S10.

Then, a target file is copied to a new folder (step S56). When the copying process is performed, the format of a target file is converted as necessary (step S58). For example, when the target file is in a format other than the JPEG format (bit map format, etc.), the format is converted into an image format in the JPEG format.

A file name is assigned according to the above-mentioned DCF naming rule to the entire target files copied in the new folder (step S60).

If the process in step S60 is completed, or if it is determined in step S52 that no image files exist, then it is determined whether or not the folder converting process has been performed on all folders (subfolders) on the lower hierarchical levels of the target folder (step S62). When the folder converting process is not performed on all subfolders, the folder converting process is performed on the subfolders as described above (step S64). If the folder of “Year2000” shown in FIG. 7 is a target folder, the folders of “AthleticMeeting”, “Park”, “BotanicalGarden” and “TurfField” are subfolders.

When the folder converting process is completed on all subfolders (or when there are no subfolders), control is returned to step S14 (as shown in FIG. 8).

Then, the folder converting process is similarly performed on other folders in the list, thereby completing the folder converting process on all folders (steps S14 and 16).

Additionally, inspecting index information (HTML file) for listing images is generated as data to be written to a CD-R, and the folder name, file name, etc. in the hard disk device 14 before conversion are left in the HTML file.

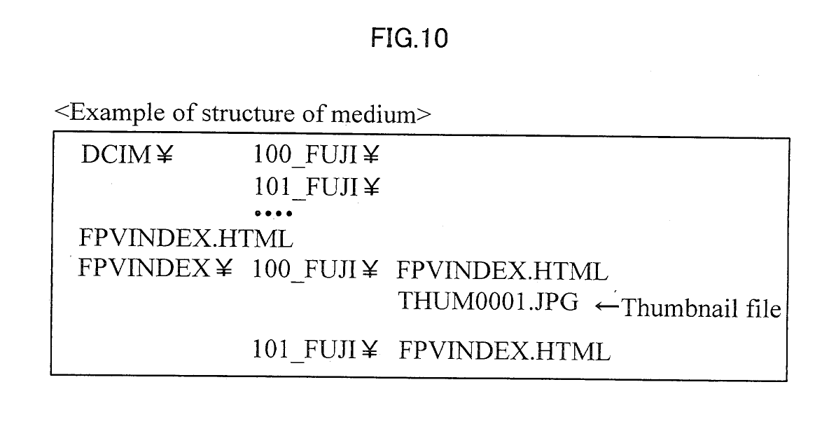

FIG. 10 shows an example of a record structure of data to be written to a CD-R. As shown in FIG. 10, a tree of the same structure containing the supplementary information for HTML is provided in the same hierarchy as the DCF image root directory DCIM. In the CD-R, no binary program (viewer software, etc.) is written, but an HTML file is written, and the HTML file is opened in the browser, thereby displaying the inspecting index screen.

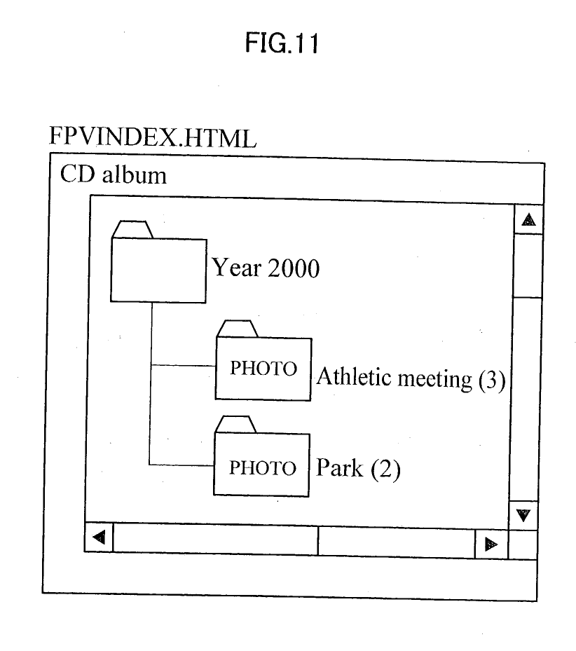

FIG. 11 shows an example of a display of a monitor screen displayed according to the HTML file (FPVINDEX.HTML of top page) written to the CD-R.

As shown in FIG. 11, the picture of a tree structure of a folder before conversion of a record structure, a folder name, etc. are displayed on the display screen, and a folder storing an image file displays the number of images.

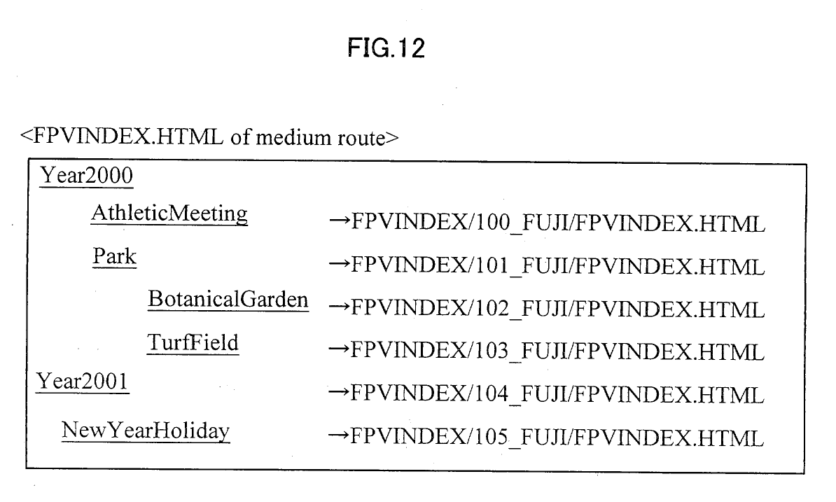

The folder storing an image file is a link button for opening an inspecting index file (thumbnail page) for displaying an image in the folder. By clicking the button, the thumbnail page is displayed. FIG. 12 shows a thumbnail page linked with the button of each folder, and the button of the underlined folder is linked with the thumbnail page.

If the folder of the athletic meeting shown in FIG. 11 is clicked, the linked thumbnail page (FPVINDEX/100_FUJI/FPVINDEX.HTML (shown in FIG. 12)) is opened.

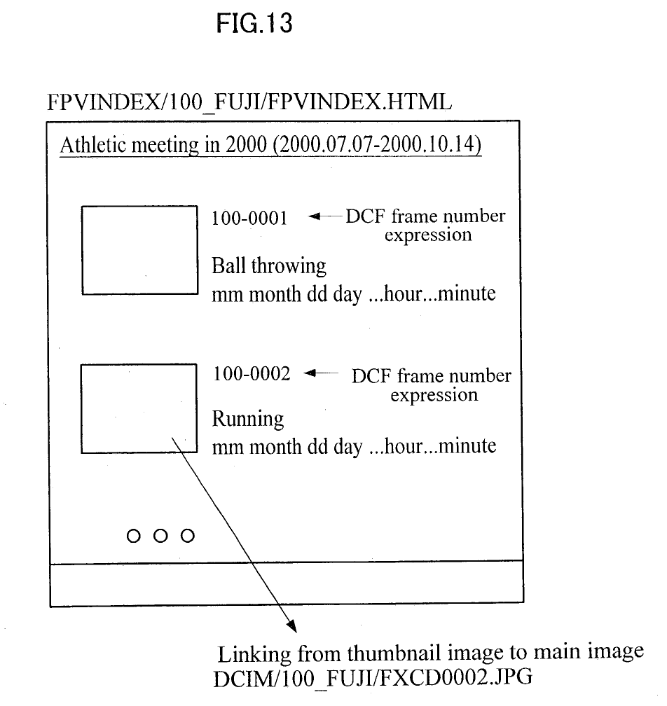

FIG. 13 shows an example of displaying the monitor screen displayed according to the thumbnail page.

As shown in FIG. 13, a list of index images in the DCF folder (DCF folder of the folder number 100) after conversion corresponding to the folder of the athletic meeting is displayed by generated thumb nail page, and the folder name before conversion (Athletic meeting), the file name (Ball throwing, Running, etc.) and the folder number and file number (100-0001, 100-0002 etc.) with DCF description after conversion are simultaneously displayed. Furthermore, the oldest and latest capture dates of the images in the folder are extracted, and the range of the date is displayed as a comment.

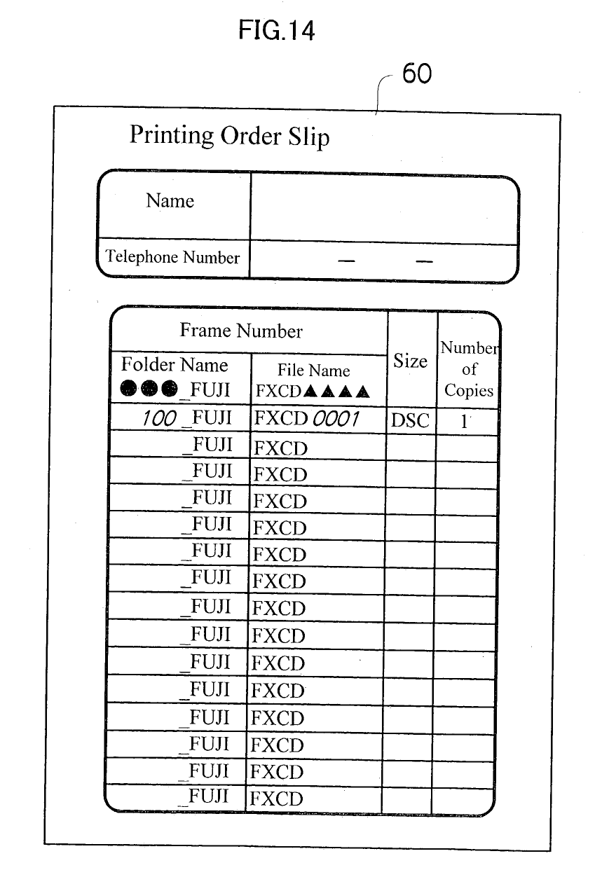

When a user prints an image written to a CD-R, the user can place a printing order by bringing the CD-R and a printing order slip 60 as shown in FIG. 14 to a printing service shop. At this time, by specifying a frame to be printed in the CD-R by a folder number and a file number with a DCF description, the image to be printed can be simply and uniquely specified without a full path name before conversion of the record structure.

Furthermore, by simultaneously displaying a folder name, a file name, etc. before and after conversion of the record structure, the correspondence between them can be easily identified.

Furthermore, in FIG. 13, each thumbnail image is assigned the link information for opening a corresponding image, and the image can be displayed by clicking the thumbnail image. In this case, since the information about the DCF file can be viewed on the screen displaying the image, the correspondence between the names before and after conversion can be identified only by displaying the folder name, the file name, etc. before conversion.

The data to be written to a CD-R includes a script file corresponding to the information about a newly generated record structure associated with the information about the record structure before conversion. An example of a description of a script file is shown below.

| | |
|---|---|
| 100-0001 | “C::MyDocuments:MyPictures:2000:AthleticMeeting:BallThrowing.JPG” |
| 100-0002 | “C::MyDocuments:MyPictures:2000:AthleticMeeting:Running01.JPG” |
| 100-0003 | “C::MyDocuments:MyPictures:2000:AthleticMeeting:Running02.JPG” |
| 101-0001 | “C::MyDocuments:MyPictures:2000:Park:DSCF0001.JPG” |
| 101-0002 | “C::MyDocuments:MyPictures:2000:Park:DSCF0002.JPG” |
| . . . | . . . |

Using the script file, the record structure before conversion can be restored according to the information written to the CD-R.

Described below is a preferred embodiment of the file display apparatus according to the present invention.

First, the record structure of the storage medium (CD-R) according to the present invention is described below.

When a user specifies a folder storing an image file in the lower hierarchical level in the hard disk device 14, and specifies backup data to be copied to the CD-R, the above-mentioned album generation program arranges the hierarchy below the folder into the data to be written to a CD-R appropriate for the record to the CD-R, and writes the resultant data to the CD-R by the CD-R/RW device 16.

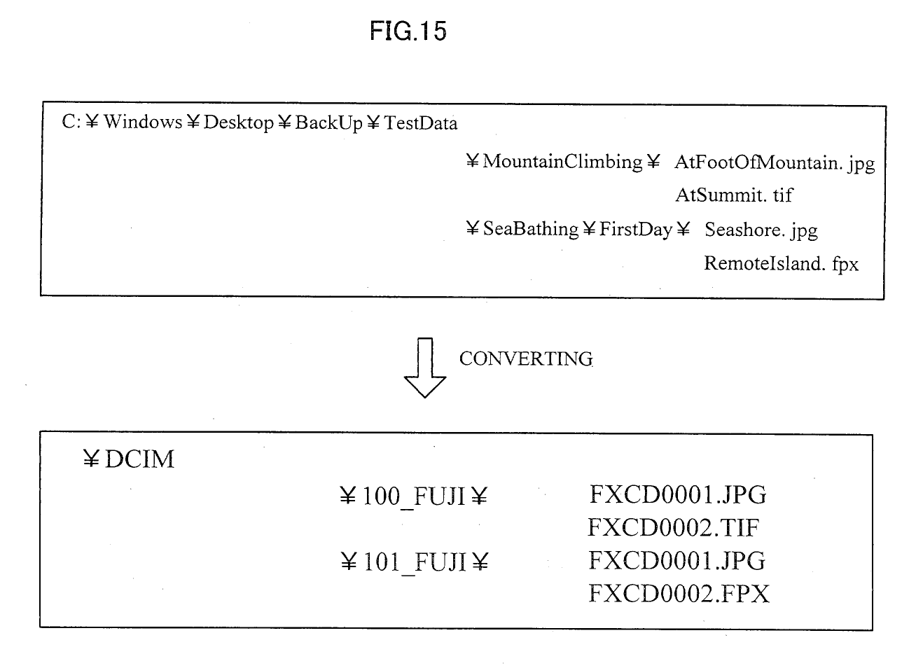

FIG. 15 shows the process of converting a record structure into a tree structure of data to be written to a CD-R from the tree structure of the hard disk device 14.

For example, if a folder “TestData” is selected from the tree structure of the hard disk device 14 shown in FIG. 15(A), then the folders and image files below the selected folder are converted into a record structure as shown in FIG. 15(B).

That is, a DCF folder (100_FUJI, 101_FUJI) is generated in the same hierarchy immediately below the DCF image root directory DCIM (Digital Camera IMages), and an image file corresponding to each DCF folder is copied.

A folder name and a file name are automatically generated according to a predetermined naming rule and assigned to the generated DCF folder and image file.

In the present embodiment, a folder name and a file name are automatically generated according to the DCF prescription, and the folder name and the file name are renamed into a manageable format.

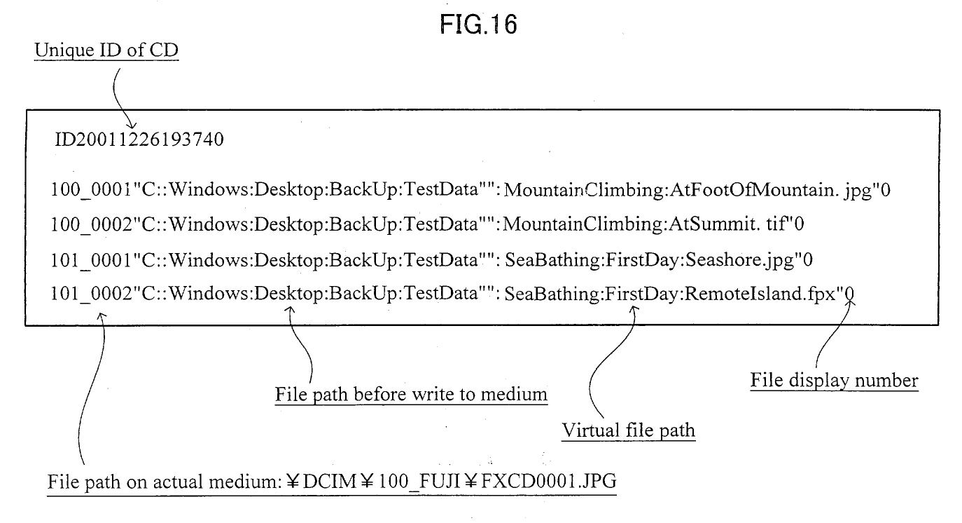

The information about the correspondence between the actual folder hierarchy of the DCF prescription on the CD-R and the folder hierarchy (virtual folder hierarchy) before conversion of the record structure and the unique ID (Identification) of the CD-R is written as a script file to the CD-R. FIG. 16 shows an example of the description of the script file. The unique ID shown in FIG. 16 indicates the date of write to CD-R, that is, the writing date is represented by 2001/12/26 19:37:40.

Described below are the filing operation and the display control on the CD-R.

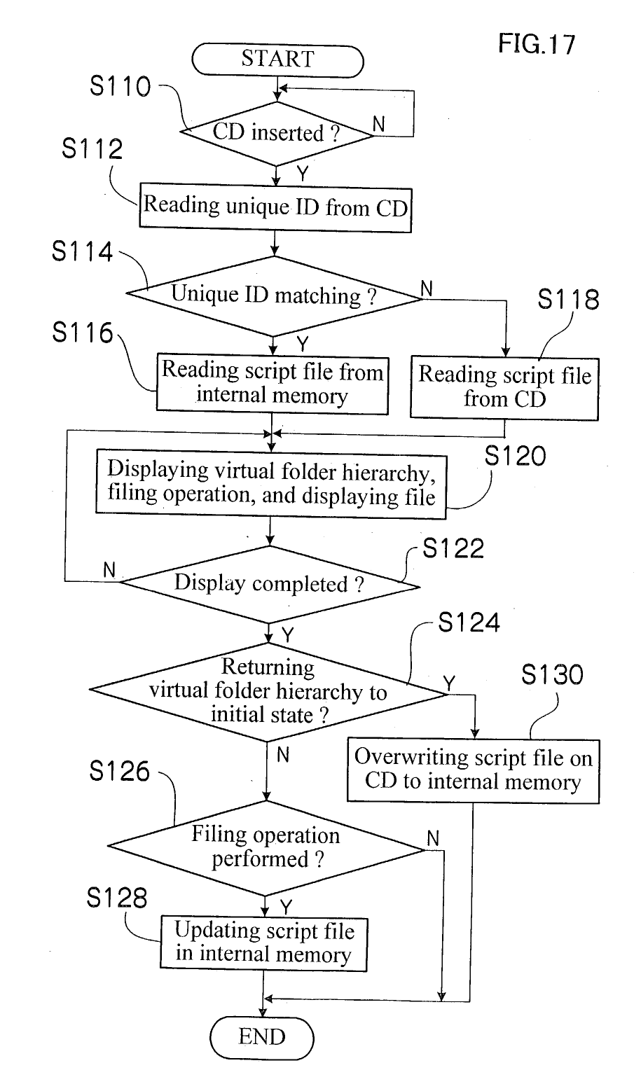

As shown in the flowchart in FIG. 17, it is determined whether or not the CD-R on which data to be written to a CD-R containing the above-mentioned script file is recorded has been inserted into the CD-R/RW device 16 (step S110). If the CD-R has been inserted, then the unique ID of the CD-R is read (step S112).

Then, it is determined whether or not internal memory (for example, the storage area storing a script file of the hard disk device 14) stores a script file having a unique ID matching the unique ID read in internal memory (step S114).

If the internal memory stores a script file having a matching unique ID, the script file having the matching unique ID is read from the internal memory (step S116). If the internal memory does not include a script file having a matching unique ID (when the CD-R is first inserted), then a script file is read from the CD-R (step S118).

Then, a virtual folder hierarchy is displayed according to the read script file, and the main image of a filing operation and an image file is displayed (step S120).

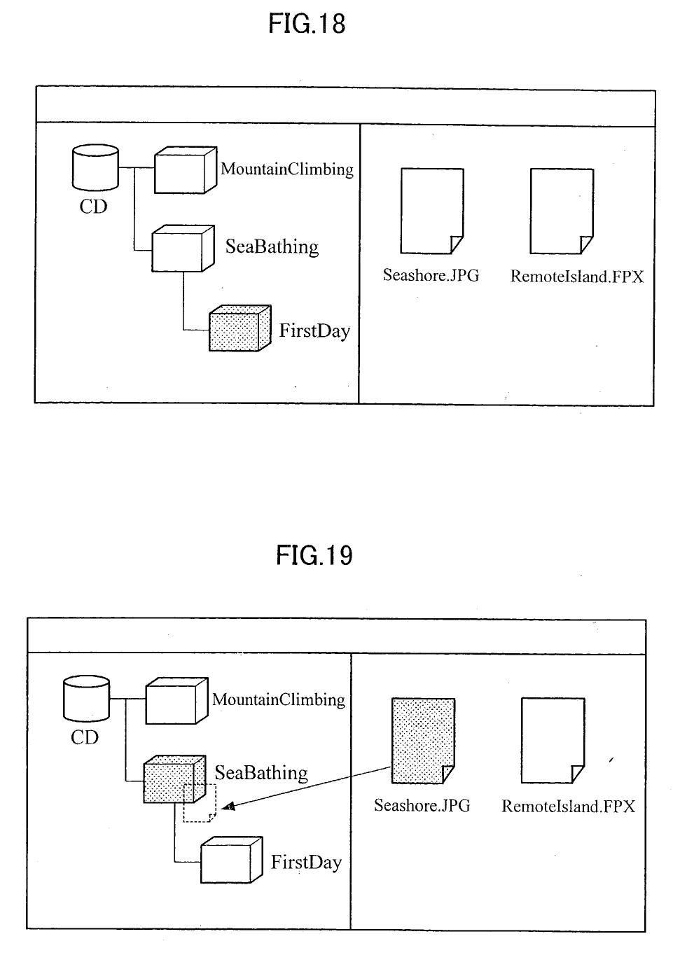

FIG. 18 shows the virtual folder hierarchy displayed on the monitor device 20 according to the script file shown in FIG. 16, and shows the case in which the folder of “FirstDay” is selected, and the image files of “Seashore.JPG” and “RemoteIsland.FPX” are displayed.

As shown in FIG. 19, by dragging and dropping the image file of “Seashore.JPG” to the folder of “SeaBathing”, the image file can be transferred in the virtual folder hierarchy. As a filing operation, not only transferring an image file, but also generating a new folder, deleting a folder, deleting a file, etc. can be performed.

Furthermore, by clicking the image file of “Remotelsland.FPX” in FIG. 18, an image file uniquely designated by a file path (101_{—}0002) on the CD-R (FIG. 16) associated with the virtual file path can be opened, and the image can be displayed.

Back in FIG. 17, in step S122, it is determined whether or not to end the display of a file. If there is an instruction to end the display of a file, then it is determined whether or not there is an instruction to restore the virtual folder hierarchy to an initial state (step S124).

If there is no instruction to restore the virtual folder hierarchy to the initial state, then it is determined whether or not a filing operation, etc. has been performed in step S120 (step S126). If a filing operation, etc. has been performed, then the script file in the internal memory is updated into a script file having the virtual folder hierarchy after the filing operation (step S128).

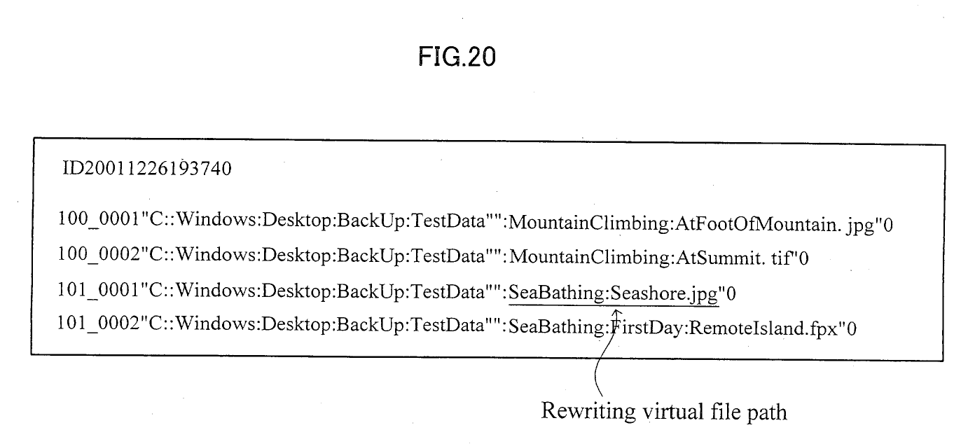

For example, as described above, if the filing operation of transferring the image file of “Seashore.JPG” to the folder of “SeaBathing” is performed (FIG. 19), then the script file shown in FIG. 16 is replaced with the script file shown in FIG. 20. If a filing operation is performed when the CD-R is first inserted, the script file having the virtual folder hierarchy after the filing operation is stored in the internal memory.

When an image is displayed on the monitor device 20 by performing an operation of opening an image file, the history of the display frequency is also recorded in the script file. When a filing operation of deleting an image file is performed, a flag indicating the deletion of a file is recorded in the script file.

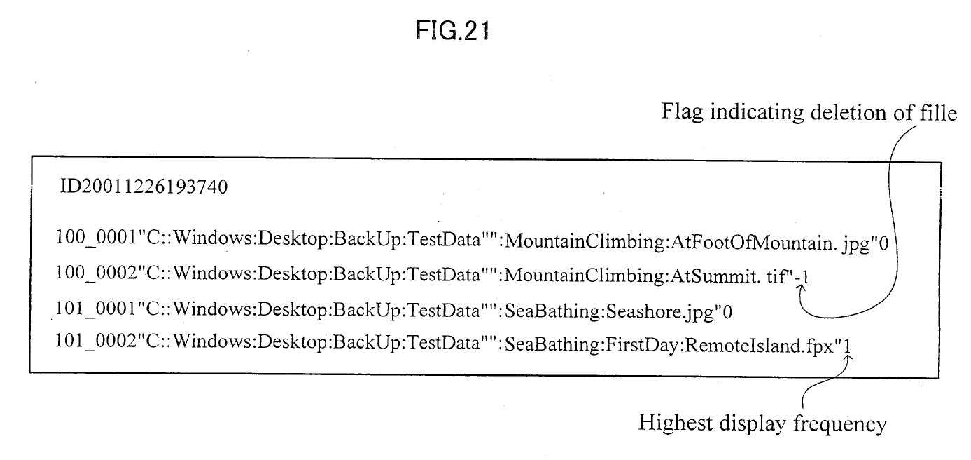

FIG. 21 shows a script file once displaying an image of an image file of “Remotelsland.fpx”, and updated when the image file of “Summit.tif” is deleted. In FIG. 21, a numeral designates a display frequency, and “−1” designates the flag of deleting a file.

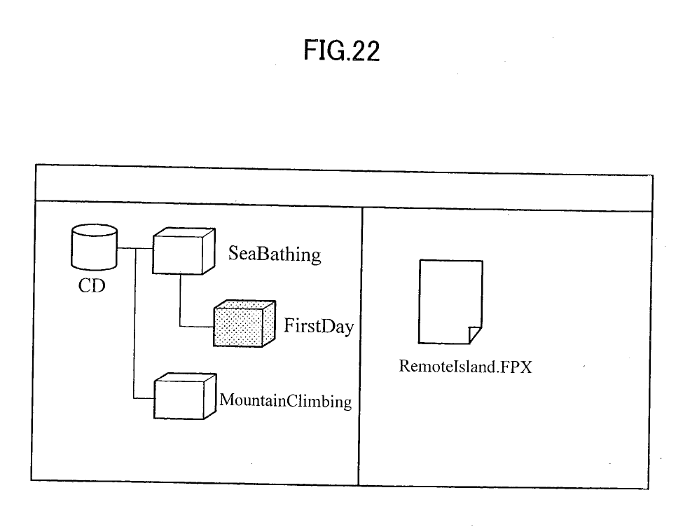

Assuming that a CD-R is inserted, and a script file shown in FIG. 21 is read from the internal memory as a script file having a matching unique ID, the virtual folder hierarchy shown in FIG. 22 is displayed.

That is, according to the history of the display frequency described in the script file, the virtual folder hierarchy is re-arranged and displayed in order from the highest display frequency. In this example, since the display frequency of the image of the image file of “RemoteIsland.fpx” is the highest (FIG. 21), the folder containing the image file of “Remotelsland.fpx” on the lower hierarchical level is displayed higher than other folders.

The image file of “Summit.tif” having a file deletion flag of “−1” is not displayed by clicking the folder of “Summit”.

Back in FIG. 17, in step S126, if no filing operation, etc. are performed, then a script file in the internal memory is not updated, thereby terminating the process. If no filing operation, etc. is performed when the CD-R is first inserted, then the script file recorded on the CD-R is stored as is in the internal memory.

On the other hand, in step S124, if there is an instruction to restore the virtual folder hierarchy to the initial state, then the script file recorded on the CD-R overrides and is stored regardless of the presence/absence of a filing operation, thereby restoring the virtual folder hierarchy to the initial state (step S130).

As described above, according to the present invention, image files stored in a complicated folder hierarchy can be automatically converted into a simple record structure and can be recorded on a storage medium with a folder name and a file name assigned according to a predetermined naming rule. Therefore, a newly generated image file can be uniquely designated by new folder name and file name, thereby easily applying a secondary use in a print service process.

Furthermore, since the storage medium also stores inspecting index information for listing images of newly generated image files as thumbnail images, an image can be easily inspected. Additionally, since the inspecting index information includes the information indicating as identifiable the correspondence between a new image file and the image file before conversion of the record structure, the correspondence between the image files before and after conversion can be easily grasped.

Furthermore, according to the present invention, the data of image files, etc. stored on a non-rewritable storage medium such as a CD-R, etc. can be displayed hierarchically, and a file and a folder can be transferred, deleted, etc. in a filing operation, and storage media can be browsed with the preceding filing operation being performed (optimized) when the subsequent storage medium file is displayed. Furthermore, in the same storage medium, different script files can be generated depending on the filing operation results for each file device, thereby successfully providing various display types.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An album generation program which is used to direct a computer to perform a function of selecting at least one folder containing an image file on at least one of lower hierarchical levels, and recording an image file contained in and below the selected folder onto a storage medium when a storing process is specified, the program causing the computer to perform the functions of:
when the image file is recorded on the storage medium, sequentially searching folders having an image file immediately below the folders;
generating a new folder for the folder having an image file immediately below the folder, and storing a target image file as a new image file in the new folder, thereby converting an existing record structure into a record structure formed by the new folder in the same hierarchy; and
giving a folder name and a file name automatically generated according to a predetermined naming rule to the stored new folder and new image file.

2. The album generation program according to claim 1, further causing the computer to perform the functions of:
generating inspecting index information listing images of the new image files as thumbnail images including the information displaying as identifiable a correspondence between a new image file and an image file before conversion of a record structure; and
recording the inspecting index information on the storage medium.

3. The album generation program according to claim 1, further causing the computer to perform the functions of:
generating inspecting index information for listing images of the new image file as thumbnail images including the link information for opening a corresponding new image file from the thumbnail images; and
recording the inspecting index information on the storage medium.

4. An album generation apparatus, comprising:
a folder selection instruction device which directs selection of a desired folder from a folder containing an image file in at least one lower hierarchical level;
a storage instruction device which directs a storing process of an image file included in and below the folders selected by the folder selection instruction device; and
a storage device which stores an image file contained in and below the folder selected by the folder selection instruction device into the storage medium when the storage instruction device directs a storing process,
wherein the storage device comprises:
a device which sequentially searches at least one folder having an image file immediately below the folder;
a device which generates a new folder on the same hierarchy for at least one folder having the image file immediately below the folder, and stores in the new folder a target image file as a new image file; and
a device which assigns a folder name and a file name automatically generated according to a predetermined naming rule to the new folder and the new image file.

5. The album generation apparatus according to claim 4, further comprising:
an inspecting index information generation device which generates inspecting index information listing images of the new image files as thumbnail images including the information displaying as identifiable a correspondence between the new image file and the image file stored on the first storage medium,
wherein the storage device stores the inspecting index information on the storage medium.

6. The album generation apparatus according to claim 4, further comprising:
an inspecting index information generation device which generates inspecting index information for listing images of the new image file as thumbnail images including the link information for opening a corresponding new image file from the thumbnail images,
wherein the storage device stores the inspecting index information on the storage medium.

7. A file display apparatus which displays a file on a non-rewritable storage medium to which a plurality of files and a script file containing information about a correspondence between an actual folder hierarchy and a virtual folder hierarchy of the files and unique identification information are written, comprising:
a storage device which stores the script file;
a read device which reads the information on the storage medium;
a determination device which determines, when a storage medium is installed in the read device, whether or not a script file having the same identification information as the script file recorded on the storage medium is stored in the storage device;
a display device which displays, if it is determined by the determination device that the script file is not stored, the virtual folder hierarchy according to the script file recorded on the storage medium, and displays, if it is determined by the determination device that the script file is stored, the virtual folder hierarchy according to the script file having the same identification information in the storage device;
a folder operation device which enables a filing operation in the displayed virtual folder hierarchy; and
a control device which allows, if the folder operation device performs the filing operation, the storage device to store the script file having the virtual folder hierarchy after filing operation.

8. The file display apparatus according to claim 7, wherein the control device overwrites, when an instruction to return to the virtual folder hierarchy on the storage medium is input, the script file recorded on the storage medium into the storage device.

9. The file display apparatus according to claim 7, further comprising:
a device which records in the script file the history of the frequency of displaying a file in the virtual folder hierarchy; and
a device which displays as rearranged the virtual folder hierarchies in an ascending order of the display frequency according to the history of the display frequency recorded in the script file.
